(19) United States
(12) Patent Application Publication
(10) Pub. No.: US 2023/0419893 A1
(43) Pub. Date: Dec. 28, 2023

(54) PIXEL DRIVING CIRCUIT AND DISPLAY PANEL

(71) Applicant: WUHAN CHINA STAR OPTOELECTRONICS SEMICONDUCTOR DISPLAY TECHNOLOGY CO., LTD, Wuhan (CN)

(72) Inventors: Xuanyun Wang, Wuhan (CN); Chao Dai, Wuhan (CN); Jianlong Wu, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 17/280,881

(22) PCT Filed: Dec. 29, 2020
(86) PCT No.: PCT/CN2020/140693

§ 371 Date: Sep. 4, 2023

(30) Foreign Application Priority Data
Dec. 24, 2020 (CN) 202011549880.X

(51) Int. Cl. G09G 3/3233

(52) U.S. Cl. CPC G09G 3/3233; G09G 2320/0247; G09G 2320/0233; G09G 2300/0842; G09G 2300/0819

(57) ABSTRACT

The disclosure provides a pixel driving circuit and a display panel. The pixel driving circuit includes a first transistor, a second transistor, a first capacitor, a second capacitor, and an organic light emitting diode; the second transistor is a low-temperature polysilicon transistor. The disclosure can improve the phenomenon of screen flickering caused by large leakage current of the display panel, thereby being beneficial to improve the brightness uniformity.

### FIELD OF DISCLOSURE

The present disclosure relates to the field of display technologies, and more particularly, to a pixel driving circuit and display panel.

### BACKGROUND OF DISCLOSURE

With developments of multimedia, display devices have become more and more important. Correspondingly, requirements for various types of display devices are getting higher and higher, especially in the field of smart phones. Ultra-high frequency driving displays, low-power driving displays, and low-frequency driving displays are all current and oncoming development demand direction.

P-channel metal oxide semiconductor field effect transistors (PMOS) are widely used as transistors in display devices, and low-temperature polysilicon (LTPS) is widely used in the field of mobile phones. However, the low-temperature polysilicon (LTPS) has a crucial weakness that the leakage current is large, especially flickers seriously occur in low-frequency displays. Metal oxide transistors (oxide) can just make up for the shortcomings of low-temperature polysilicon (LTPS). A combination of both fully utilizes their respective advantages to perfectly adapt to high-standard requirements of oncoming displays.

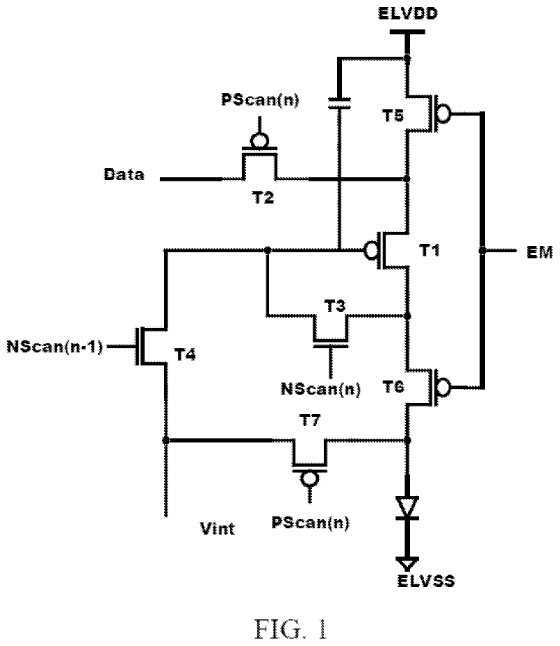

Furthermore, as shown in FIG. 1, the current display panel pixel circuit generally adopts a 7T1C structure. This circuit has a poor compensating effect on a threshold voltage Vth. The threshold voltage Vth may be negative, and it is difficult for a data voltage to be stably stored in a storage capacitor. The data signal may be gradually lost, and cause screen flickering, thereby affecting product quality.

### SUMMARY OF DISCLOSURE

### Technical Problems

The object of the present disclosure is to provide a pixel driving circuit and a display panel to solve the technical problems of large leakage current of the display panel causing screen flickering, and poor threshold voltage Vth compensation effect resulting in serious loss of data signals to cause screen flickering.

### TECHNICAL SOLUTION TO TECHNICAL PROBLEM

### Technical Solutions

To achieve the above object, the present disclosure provides a pixel driving circuit. The pixel driving circuit includes a first transistor T1, a second transistor T2, a third transistor T3, a fourth transistor T4, a first capacitor Cst, a second capacitor Cboost, and an organic light emitting diode D1; the second transistor is a low temperature polysilicon transistor; a gate of the first transistor T1 is connected to a first node Q, a source of the first transistor T1 is connected to a second node P, and a drain of the first transistor T1 is connected to a third node B; a gate of the second transistor T2 is connected to a first scan signal Scan(n), a source of the second transistor T2 is connected to a data signal Data, and a drain of the second transistor T2 is connected to the second node P; a gate of the third transistor T3 is connected to an enabling signal, a source of the third transistor T3 is connected to a first power signal, a drain of the third transistor T3 is connected to the second node; a gate of the fourth transistor is connected to the enabling signal, a source of the fourth transistor is connected to the third node, and a drain of the fourth transistor is connected to an anode of the organic light emitting diode; one end of the first capacitor Cst is connected to the first power signal ELVDD, and the other end of the first capacitor is connected to the first node Q; one end of the second capacitor Cboost is connected to the gate of the second transistor T2 and the other end of the second capacitor is connected to the first node Q; the anode of the organic light emitting diode D1 is connected to the third node B, and a cathode of the organic light emitting diode D1 is connected to a second power signal ELVSS.

Further, the first transistor T1, the third transistor T3, and the fourth transistor T4 are low temperature polysilicon transistors.

Further, the pixel driving circuit further includes a fifth transistor T5; a gate of the fifth transistor T5 is connected to the first scan signal Scan(n), and a first electrode of the fifth transistor is connected to the first node Q, a second electrode of the fifth transistor is connected to the third node B; the fifth transistor is an oxide semiconductor transistor or a low-temperature polysilicon transistor; the first electrode of the fifth transistor T5 is a source, and the second electrode of the fifth transistor T5 is a drain if the fifth transistor T5 is a p-type transistor; the first electrode of the fifth transistor T5 is a drain, and the second electrode of the fifth transistor T5 is a source if the fifth transistor T5 is an n-type transistor.

Further, the pixel driving circuit further includes an eighth transistor T8 and a fifth transistor T5; A gate of the eighth transistor T8 is connected to the first scan signal Scan(n), and a source of the eighth transistor T8 is connected to the first node Q; the eighth transistor T8 is an oxide semiconductor transistor; a gate of the fifth transistor T5 is connected to the first scan signal Scan(n), and a first electrode of the fifth transistor T5 is connected to the first node Q, a second electrode of the fifth transistor is connected to the third node B; the fifth transistor T5 is an oxide semiconductor transistor or a low-temperature polysilicon transistor; the first electrode of the fifth transistor T5 is a source, and the second electrode of the fifth transistor T5 is a drain if the fifth transistor T5 is a p-type transistor; the first electrode of the fifth transistor T5 is a drain, and the second electrode of the fifth transistor T5 is a source if the fifth transistor T5 is an n-type transistor.

Further, the pixel driving circuit further includes a sixth transistor T6; a gate of the sixth transistor T6 is connected to a second scan signal Scan(n-1), and a first electrode of the sixth transistor T6 is connected to a first electrode of the fifth transistor T5; the sixth transistor T6 is an oxide semiconductor transistor or a low-temperature polysilicon transistor.

Further, a second electrode of the sixth transistor T6 is connected to a reference voltage Vint, or is connected to the anode of the organic light emitting diode D1; a first electrode of the sixth transistor T6 is a source, and the second electrode of the sixth transistor T6 is a drain if the sixth transistor T6 is a p-type transistor; the first electrode of the sixth transistor T6 is a drain, and the second electrode of the sixth transistor T6 is a source if the sixth transistor T6 is an n-type transistor.

Further, the pixel driving circuit further includes a seventh transistor T7; a gate of the seventh transistor T7 is connected to the enabling signal EM, a source of the seventh T7 is connected to a reference voltage Vint, and a drain of the seventh T7 is connected to the anode of the organic light emitting diode D1; the seventh transistor T7 is an oxide semiconductor transistor or a low temperature polysilicon transistor.

Further, the pixel driving circuit further includes a seventh transistor T7; a gate of the seventh transistor T7 is connected to the second scan signal Scan(n-1), and a source of the seventh transistor is connected to the third node B, a drain of the seventh transistor is connected to the anode of the organic light emitting diode D1; the seventh transistor T7 is an oxide semiconductor transistor or a low temperature polysilicon transistor.

The present disclosure also provides a display panel including the abovementioned pixel driving circuit.

### BENEFICIAL EFFECT OF PRESENT DISCLOSURE

### Beneficial Effect

The technical effect of the present disclosure is to provide a pixel driving circuit and a display panel, which suppress the potential change of the first node Q within one frame by using the low leakage characteristics of the metal oxide transistors. The second capacitor Cboost is connected between the first node Q and the gate of the second transistor T2. The function of the capacitor is to adjust the potential of the first node Q, thereby changing the range of the data signal Data within the gray scale of 0-255, which can improve the phenomenon of screen flickering caused by the large leakage current of the display panel. In addition, the second capacitor Cboost also has the compensating effect on the threshold voltage Vth, avoiding the screen flickering caused by the serious loss of the data signal, and being beneficial to improving the brightness uniformity.

### BRIEF DESCRIPTION OF DRAWINGS OF PRESENT DISCLOSURE

### DESCRIPTION OF DRAWINGS

FIG. 1 is a structurally schematic diagram of a conventional pixel driving circuit.

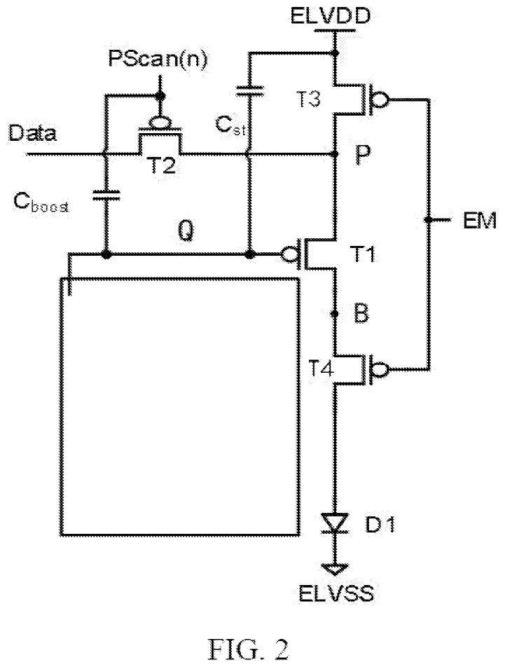

FIG. 2 is an entire structurally schematic diagram of the pixel driving circuit according to an embodiment of the present disclosure.

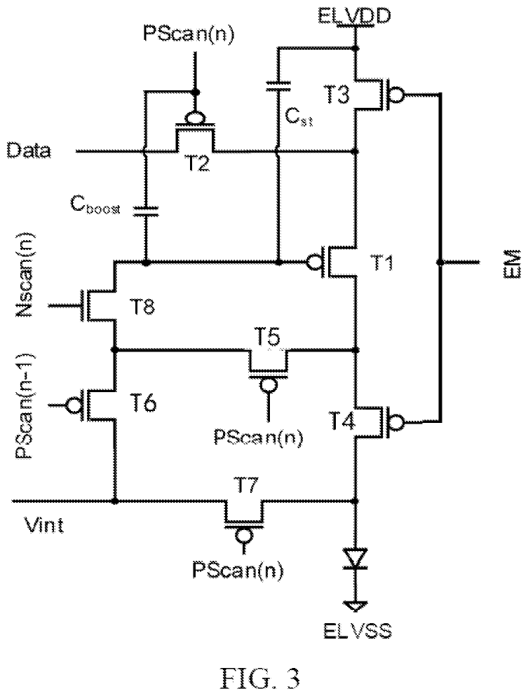

FIG. 3 is a structurally schematic diagram of the first pixel driving circuit according to an embodiment of the present disclosure.

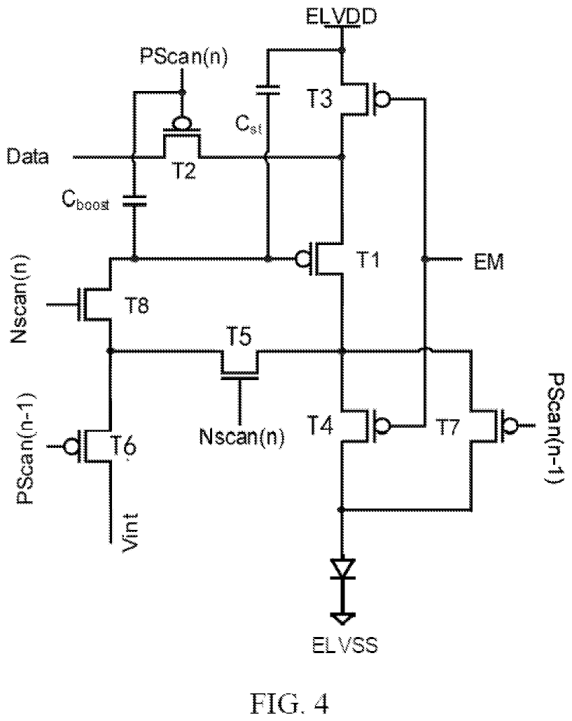

FIG. 4 is a structurally schematic diagram of the second pixel driving circuit according to an embodiment of the present disclosure.

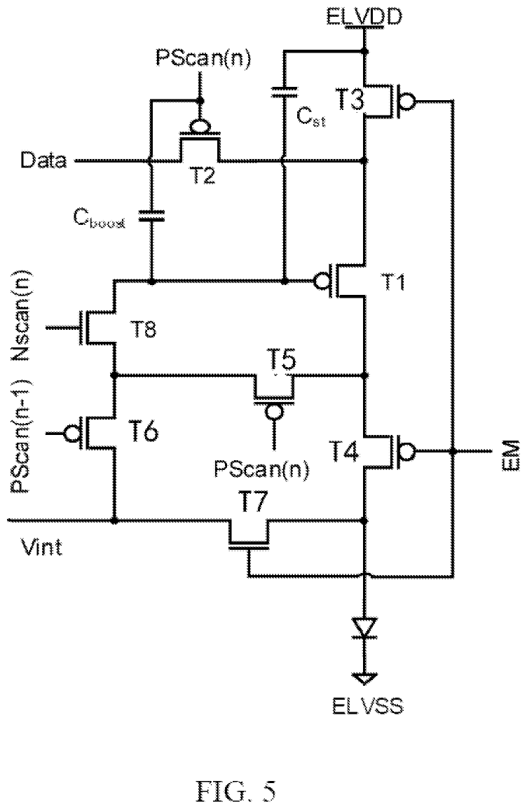

FIG. 5 is a structurally schematic diagram of the third pixel driving circuit according to an embodiment of the present disclosure.

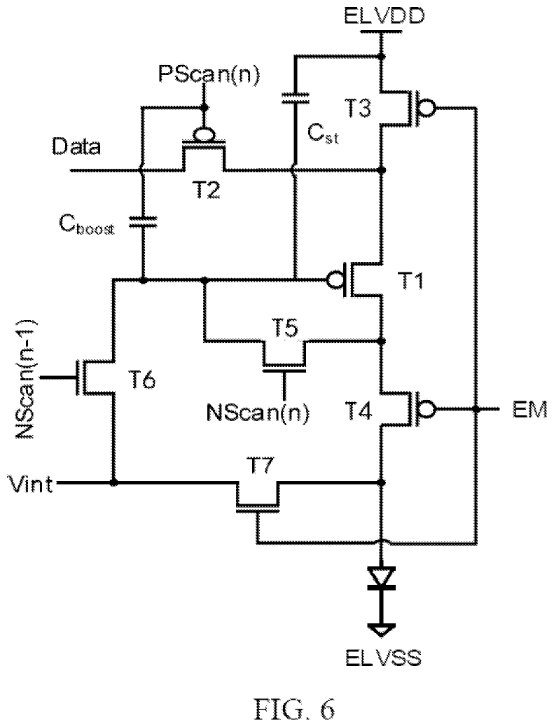

FIG. 6 is a structurally schematic diagram of the fourth pixel driving circuit according to an embodiment of the present disclosure.

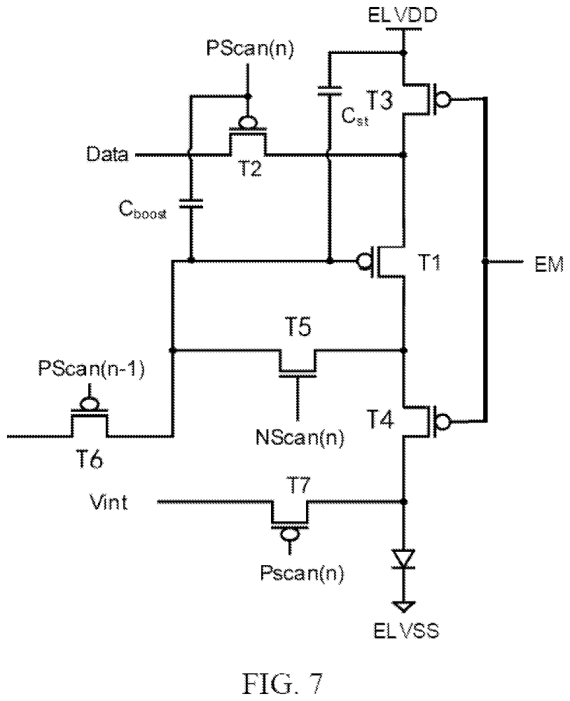

FIG. 7 is a structurally schematic diagram of the fifth pixel driving circuit according to an embodiment of the present disclosure.

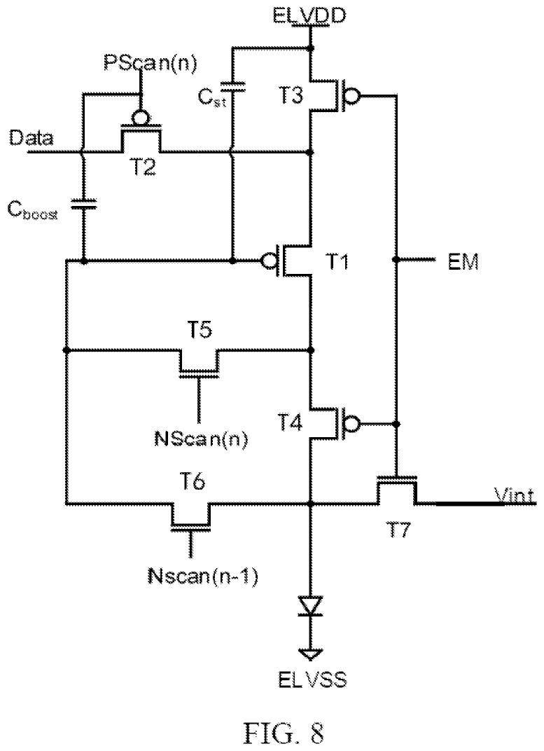

FIG. 8 is a structurally schematic diagram of the sixth pixel driving circuit according to an embodiment of the present disclosure.

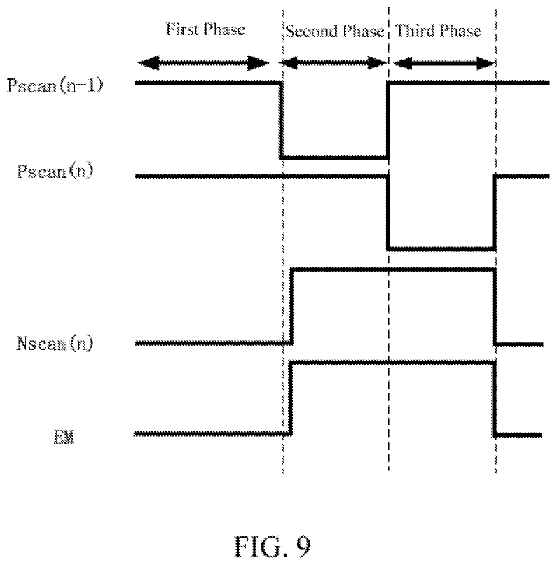

FIG. 9 is a waveform diagram used by the pixel driving circuit shown in FIG. 3, FIG. 4, and FIG. 5 according to an embodiment of the present disclosure.

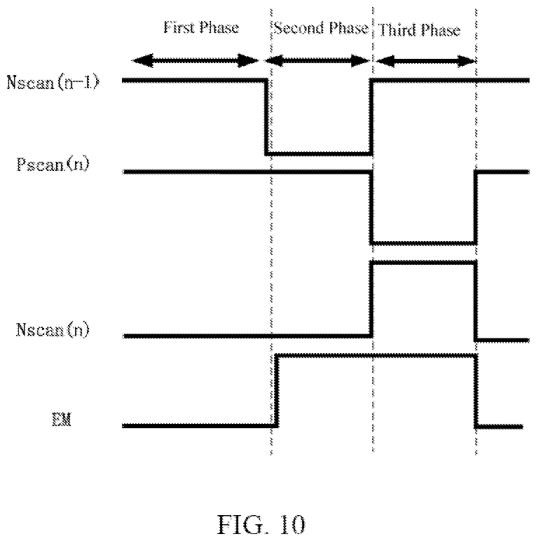

FIG. 10 is a waveform diagram used by the pixel driving circuit shown in FIG. 6 according to an embodiment of the present disclosure.

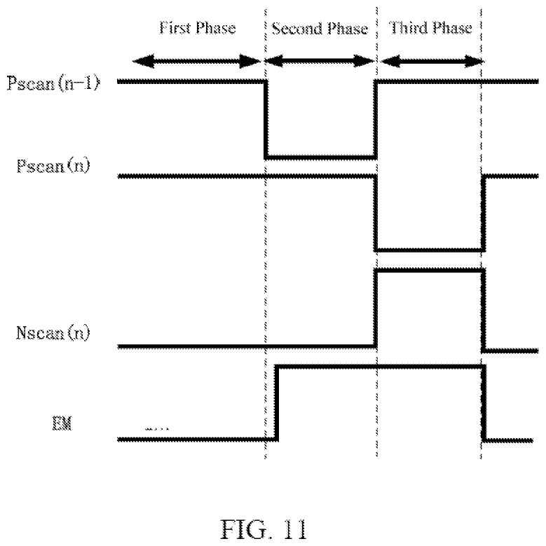

FIG. 11 is a waveform diagram used by the pixel driving circuit shown in FIG. 7 according to an embodiment of the present disclosure.

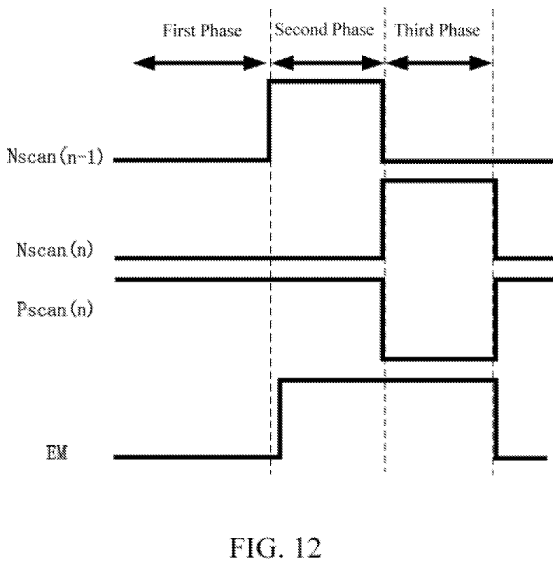

FIG. 12 is a waveform diagram used by the pixel driving circuit shown in FIG. 8 according to an embodiment of the present disclosure.

### DETAILED DESCRIPTION OF PREFERRED EMBODIMENTS

### EMBODIMENTS OF THE PRESENT DISCLOSURE

The technical solutions in the embodiments of the present disclosure are clearly and completely described below in conjunction with the drawings in the embodiments of the present disclosure. Obviously, the described embodiments are only a part of the embodiments of the present disclosure, rather than all the embodiments. Based on the embodiments of the present disclosure, all other embodiments obtained by those skilled in the art without creative work shall be within the protection scope of the present disclosure.

In the description of the disclosure, it should be noted that the terms “installation”, “link”, and “connection” should be interpreted broadly unless otherwise clearly specified and limited. For example, they can be fixedly or detachable connected, or integrally connected; they can be mechanically connected, or electrically connected, or can communicate with each other; they can be directly connected, or indirectly connected through an intermediate medium, they can be the internal communication of two components or the interaction of two components. For those of ordinary skill in the art, the specific meaning of the above terms in the disclosure can be understood according to the specific situation.

As shown in FIG. 2, an embodiment of the present disclosure provides a pixel driving circuit. The pixel driving circuit includes a first transistor T1, a second transistor T2, a third transistor T3, a fourth transistor T4, a first capacitor Cst, a second capacitor Cboost and an organic light emitting diode D1. Specifically, the second transistor T2 is a low-temperature polysilicon transistor. A gate of the first transistor T1 is connected to a first node Q, a source of the first transistor T1 is connected to a second node P, a drain of the first transistor T1 is connected to a third node B. A gate of the second transistor T2 is connected to a first scan signal Scan(n), a source of the second transistor T2 is connected to a data signal Data, and a drain of the second transistor T2 is connected to the second node P. A gate of the third transistor T3 is connected to an enabling signal EM, a source of the third transistor T3 is connected to a first power signal ELVDD, and a drain of the third transistor T3 is connected to the second node P. The pixel driving circuit also includes a fourth transistors T4 which is provided between the first transistor T1 and the organic light emitting diode D1. A gate of the fourth transistor T4 is connected to the enabling signal EM, a source of the fourth transistor T4 is connected to the third node B, a drain of the fourth transistor T4 is connected to an anode of the organic light emitting diode D1. One end of the first capacitor Cst is connected to the first power signal ELVDD, and the other end is connected to the first node Q. One end of the second capacitor Cboost is connected to the gate of the second transistor T2, and the other end is connected to the first node Q. The anode of the organic light emitting diode D1 is connected to the third node B, and a cathode of the organic light emitting diode D1 is connected to a second power signal ELVSS.

In this embodiment, the source and drain of all transistors can be source or drain. The first transistor T1, the third transistor T3, and the fourth transistor T4 are low temperature polysilicon transistors.

The embodiment suppresses the potential change of the first node Q within a frame time by using low leakage characteristics of the metal oxide transistors. The second capacitor Cboost is connected between the first node Q and the gate of the second transistor T2. The function of the capacitor is to adjust the potential of the first node Q, thereby changing the range of the data signal Data within the gray scale of 0-255, which can improve the phenomenon of screen flickering caused by the large leakage current of the display panel. In addition, the second capacitor Cboost also has the compensating effect on a threshold voltage Vth, avoiding the screen flickering caused by the serious loss of the data signal, and being beneficial to improving the brightness uniformity.

In the embodiment, the pixel driving circuit may be provided with the third transistor T3 and the fourth transistor T4 together, or may be provided with the third transistor T3 or the fourth transistor T4 separately. The purpose of providing the third transistor T3 and/or the fourth transistor T4 is to realize the control of turning on and off the organic light emitting diode D1 by an enabling signal EM.

The specific circuit structures of the above three structures are shown in FIG. 3 to FIG. 8. In the Figures, the third transistor T3 and the fourth transistor T4 provided together are as an example for illustration, wherein one of the third transistor T3 and the fourth transistor T4 may be removed.

It is worth noting that, for the sake of brevity, the symbols of the first node Q, the second node P, the third node B, and the organic light emitting diode D1 are omitted in FIG. 3 to FIG. 8, and their actual positions are the same as those shown in FIG. 2. Scan(n), PScan(n), and NScan(n) used in FIG. 3 to FIG. 8 all represent the first scan signal Scan(n), wherein the PScan(n) represents that a transistor connected by the PScan(n) is a P-type thin film, the NScan(n) represents that a transistor connected by the NScan(n) is an N-type thin film transistor. In the same way, Scan(n-1), PScan(n-1), NScan(n-1) used in FIG. 3 to FIG. 8 all represent the second scan signal Scan(n-1), wherein the PScan(n-1) represents that a transistor connected by the PScan(n-1) is a P-type thin film transistor, and the NScan(n-1) represents that a transistor connected by the NScan(n-1) is an N-type thin film transistor. In addition, in FIG. 2 to FIG. 8, a circled symbol on the gate portion is used to indicate a low-temperature polysilicon transistor, and a symbol without a circle on the gate portion is used to indicate an oxide semiconductor transistor.

As shown in FIG. 3 to FIG. 8, the pixel driving circuit further includes a fifth transistor T5. A gate of the fifth transistor T5 is connected to the first scan signal Scan(n), a first electrode of the fifth transistor is connected to the first node Q, and a second electrode thereof is connected to the third node B. The fifth transistor T5 is an oxide semiconductor transistor or a low-temperature polysilicon transistor. The first electrode of the fifth transistor T5 is a source, and the second electrode of the fifth transistor T5 is a drain if the fifth transistor T5 is a p-type transistor. The first electrode of the fifth transistor T5 is a drain, and the second electrode of the fifth transistor T5 is a source if the fifth transistor T5 is an n-type transistor.

In the embodiment, the pixel driving circuit further includes a sixth transistor T6. A gate of the sixth transistor T6 is connected to the second scan signal Scan(n-1), and a source thereof is connected to the first electrode of the fifth transistor T5. The sixth transistor T6 is an oxide semiconductor transistor or a low temperature polysilicon transistor.

In the embodiment, a drain of the sixth transistor T6 is connected to a reference voltage Vint, or is connected to the anode of the organic light emitting diode D1. The first electrode of the sixth transistor T6 is a source, and the second electrode of the sixth transistor T6 is a drain if the sixth transistor T6 is a p-type transistor. The first electrode of the sixth transistor T6 is a drain, and the second electrode of the sixth transistor T6 is a source if the sixth transistor T6 is an n type transistor.

As shown in FIG. 3, FIG. 5, FIG. 6, FIG. 7, and FIG. 8, in the embodiment, the pixel driving circuit further includes a seventh transistor T7. A gate of the seventh transistor T7 is connected to the first scan signal Scan(n) or the enabling signal EM, a source of the seventh transistor is connected to the reference voltage Vint, and a drain thereof is connected to the anode of the organic light emitting diode D1. The seventh transistor T7 is an oxide semiconductor transistor or a low temperature polysilicon transistor.

As shown in FIG. 3, FIG. 5, FIG. 6, FIG. 7, and FIG. 8, a source of the seventh transistor T7 can be connected to the drain of the sixth transistor T6, or can be disposed separately from each other. In FIG. 3, FIG. 5, FIG. 6, and FIG. 8, the source of the seventh transistor T7 is connected to the drain of the sixth transistor T6. In FIG. 7, the source of the seventh transistor T7 and the drain of the sixth transistor T6 are disposed separately from each other.

As shown in FIG. 7, if the source of the seventh transistor T7 and the drain of the sixth transistor T6 are disposed separately from each other, the input reference voltage Vint of both may be identical or different.

In another pixel driving circuit structure, as shown in FIG. 4, the gate of the seventh transistor T7 is connected to the second scan signal Scan(n-1), the source thereof is connected to the third node B, and the drain thereof is connected to the anode of the organic light emitting diode D1.

As shown in FIG. 3, FIG. 4, and FIG. 5, in the embodiment, the pixel driving circuit further includes an eighth transistor T8 and the fifth transistor T5. A gate of the eighth transistor T8 is connected to the first scan signal Scan(n), a drain thereof is connected to the first node Q. The eighth transistor T8 is an oxide semiconductor transistor. The gate of the fifth transistor T5 is connected to the first scan signal Scan(n), a first electrode thereof is connected to the first node Q, and a second electrode thereof is connected to the third node B. The fifth transistor T5 is an oxide semiconductor transistor or a low-temperature polysilicon transistor. The first electrode of the fifth transistor T5 is a source, and the second electrode of the fifth transistor T5 is a drain if the fifth transistor T5 is a p-type transistor. The first electrode of the fifth transistor T5 is a drain, and a second electrode of the fifth transistor T5 is a source if the fifth transistor T5 is an n-type transistor.

In addition, the specific embodiment of the present disclosure includes 6 types of circuit connection relationships, but is not limited thereto. The core content of the present disclosure is the connection relationship of the second capacitor Cboost. The second capacitor Cboost is connected between the first node Q and the gate of the second transistor T2. The function of the capacitor is to adjust the potential of the first node Q, thereby changing the range of the data signal Data within the gray scale of 0-255, which can improve the phenomenon of screen flickering caused by the large leakage current of the display panel. In addition, the second capacitor Cboost also has the compensating effect on the threshold voltage Vth, avoiding the screen flickering caused by the serious loss of the data signal, and being beneficial to improving the brightness uniformity.

In use, the pixel drive circuits shown in FIG. 3, FIG. 4, and FIG. 5 are all driven by the waveform diagram shown in FIG. 9. The waveform includes a first phase, a second phase and a third phase which are cycled sequentially. The first phase is the original state phase, the second phase is the initialization state phase, and the third phase is the program execution state phase.

In the pixel driving circuit shown in FIG. 3, in the first phase, the scan signals PScan(n) and PScan(n-1) are high potential, the scan signal NScan(n) is low potential, and the enabling signal EM is low potential. At this moment, the second transistor T2, the fifth transistor T5, the sixth transistor T6 and the seventh transistor T7 are turned on, and the third transistor T3 the fourth transistor T4 and the eighth transistor T8 are turned off. In the second phase, the scan signals PScan(n) and NScan(n) are high potential, the enabling signal EM is high potential, and the scan signal PScan(n-1) is low potential. At the moment, the first transistor T1, the second transistor T2, the third transistor T3, the fourth transistor T4, the fifth transistor T5, the seventh transistor T7 and the eighth transistor T8 are turned on, and the sixth transistor T6 is turned off. In the third phase, the scan signals PScan(n-1) and NScan(n) are high potential, the enabling signal EM is high potential, and the scan signal PScan(n) is low potential. At this moment, the first transistor T1, the third transistor T3, the fourth transistor T4, the sixth transistor T6, the seventh transistor T7 and the eighth transistor T8 are turned on, and the second transistor T2 and the fifth transistor T5 are turned off.

In the pixel driving circuit shown in FIG. 4, in the first phase, the scan signals PScan(n) and PScan(n-1) are high potential, the scan signal NScan(n) is low potential, and the enabling signal EM is low potential. At this moment, the second transistor T2, the sixth transistor T6 and the seventh transistor T7 are turned on, and the third transistor T3, the fourth transistor T4, the fifth transistor T5 and the eighth transistor T8 are turned off. In the second phase, the scan signals PScan(n) and NScan(n) are high potential, the enabling signal EM is high potential, and the scan signal PScan(n-1) is low potential. The first transistor T1, the second transistor T2, the third transistor T3, the fourth transistor T4, the fifth transistor T5 and the eighth transistor T8 are turned on, and the sixth transistor T6 and the seventh transistor T7 is turned off. In the third phase, the scan signals PScan(n-1) and NScan(n) are high potential, the enabling signal EM is high potential, and the scan signal PScan(n) is low potential. The first transistor T1, the third transistor T3, the fourth transistor T4, the fifth transistor T5, the sixth transistor T6, the seventh transistor T7 and the eighth transistor T8 are turned on, and the second transistor T2 is turned off.

In the pixel driving circuit shown in FIG. 5, in the first phase, the scan signals PScan(n) and PScan(n-1) are high potential, the scan signal NScan(n) is low potential, and the enabling signal EM is low potential. At this moment, the second transistor T2, the fifth transistor T5 and the sixth transistor T6 are turned on, and the third transistor T3, the fourth transistor T4, the seventh transistor T7 and the eighth transistor T8 are turned off. In the second phase, the scan signals PScan(n) and NScan(n) are high potential, the enabling signal EM is high potential, and the scan signal PScan(n-1) is low potential. The first transistor T1, the second transistor T2, the third transistor T3, the fourth transistor T4, the fifth transistor T5, the seventh transistor T7 and the eighth transistor T8 are turned on, and the sixth transistor T6 is turned off. In the third phase, the scan signals PScan(n-1) and NScan(n) are high potential, the enabling signal EM is high potential, and the scan signal PScan(n) is low potential. The first transistor T1, the third transistor T3, the fourth transistor T4, the sixth transistor T6, the seventh transistor T7 and the eighth transistor T8 are turned on, and the second transistor T2 and the fifth transistor T5 are turned off.

In use, the pixel driving circuit shown in FIG. 6 is driven by the waveform diagram shown in FIG. 10. The waveform includes the first phase, the second phase and the third phase that are cycled sequentially. The first phase is an original state phase, the second phase is an initialization state phase, and the third phase is a program execution state phase.

In the pixel driving circuit shown in FIG. 6, in the first phase, the scan signals PScan(n) and NScan(n-1) are high potential, the scan signal NScan(n) is low potential, and the enabling signal EM is low potential. At this moment, the second transistor T2, the fifth transistor T5 and the sixth transistor T6 are turned on, and the third transistor T3, the fourth transistor T4 and the seventh transistor T7 are turned off. In the second phase, the scan signal PScan(n) is high potential, the enabling signal EM is high potential, and the scan signals NScan(n-1) and NScan(n) are low potential. At this moment, the first transistor T1, the second transistor T2, the third transistor T3, the fourth transistor T4, the seventh transistor T7 and the eighth transistor T8 are turned on, and the fifth transistor T5 and the sixth transistor T6 are turned off. In the third phase, the scan signals NScan(n-1) and NScan(n) are high potential, the enabling signal EM is high potential, and the scan signal PScan(n) is low potential. At this moment, the first transistor T1, the third transistor T3, the fourth transistor T4, the fifth transistor T5, the sixth transistor T6, the seventh transistor T7 and the eighth transistor T8 are turned on, and the second transistor T2 is turned off.

In use, the pixel driving circuit shown in FIG. 7 is driven by the waveform diagram shown in FIG. 11. The waveform includes the first phase, the second phase and the third phase that are cycled sequentially. The first phase is an original state phase, the second phase is an initialization state phase, and the third phase is a program execution state phase.

In the pixel driving circuit shown in FIG. 7, in the first phase, the scan signals PScan(n) and PScan(n-1) are high potential, the scan signal NScan(n) is low potential, and the enabling signal EM is low potential. At this moment, the second transistor T2, the sixth transistor T6 and the seventh transistor T7 are turned on, and the third transistor T3, the fourth transistor T4 and the fifth transistor T5 are turned off. In the second phase, the scan signal PScan(n) is high potential, the enabling signal EM is high potential, and the scan signals PScan(n-1) and NScan(n) are low potential. At this moment, the first transistor T1, the second transistor T2, the third transistor T3, the fourth transistor T4, the seventh transistor T7 and the eighth transistor T8 are turned on, and the fifth transistor T5 and the sixth transistor T6 are turned off. In the third phase, the scan signals PScan(n-1) and NScan(n) are high potential, the enabling signal EM is high potential, and the scan signal PScan(n) is low potential. At this moment, the first transistor T1, the third transistor T3, the fourth transistor T4, the fifth transistor T5, the sixth transistor T6 and the eighth transistor T8 are turned on, and the second transistor T2 and the seventh transistor T7 are turned off.

In use, the pixel driving circuit shown in FIG. 8 is driven by the waveform diagram shown in FIG. 12. The waveform includes the first phase, the second phase and the third phase that are cycled sequentially. The first phase is an original state phase, the second phase is an initialization state phase, and the third phase is a program execution state phase.

In the pixel driving circuit shown in FIG. 8, in the first phase, the scan signal PScan(n) is high potential, the scan signals NScan(n) and NScan(n-1) are low potential, and the enabling signal EM is low potential. At this moment, the second transistor T2 is turned on, and the third transistor T3, the fourth transistor T4, the fifth transistor T5, the sixth transistor T6 and the seventh transistor T7 are turned off. In the second phase, the scan signal NScan(n-1) is high potential, the enabling signal EM is high potential, and the scan signals PScan(n) and NScan(n) are low potential. At this moment, the first transistor T1, the third transistor T3, the fourth transistor T4, the sixth transistor T6, the seventh transistor T7 and the eighth transistor T8 are turned on, and the second transistor T2 and the fifth transistor T5 are turned off. In the third phase, the scan signal NScan(n) is high potential, the enabling signal EM is high potential, and the scan signals NScan(n-1), PScan(n) are low potential. At this moment, the first transistor T1, the third transistor T3, the fourth transistor T4, the fifth transistor T5, the seventh transistor T7 and the eighth transistor T8 are turned on, and the second transistor T2 and the sixth transistor T6 are turned off.

Based on the same inventive concept, the present disclosure also provides a display panel including the abovementioned pixel driving circuit. The display panel in the embodiment of the present disclosure may be any product or component with a display function, such as a mobile phone, a tablet computer, a television, a monitor, a notebook computer, a digital photo frame, a navigator etc.

The working principle of the display panel provided in the embodiment is consistent with the working principle of the abovementioned pixel driving circuit embodiment. The specific structural relationships and working principles refer to the abovementioned pixel driving circuit embodiments and are not repeated herein.

The technical effect of the present disclosure is to provide a pixel driving circuit and a display panel, which suppress the potential change of the first node Q within one frame by using the low leakage characteristics of the metal oxide transistors. The second capacitor Cboost is connected between the first node Q and the gate of the second transistor T2. The function of the capacitor is to adjust the potential of the first node Q, thereby changing the range of the data signal Data within the gray scale of 0-255, which can improve the phenomenon of screen flickering caused by the large leakage current of the display panel. In addition, the second capacitor Cboost also has the compensating effect on the threshold voltage Vth, avoiding the screen flickering caused by the serious loss of the data signal, and being beneficial to improving the brightness uniformity.

In the above-mentioned embodiments, the description of each embodiment has its own emphasis. For portions that are not described in detail in an embodiment, reference may be made to related descriptions of other embodiments.

The above is a detailed introduction of a pixel driving circuit and a display panel provided by the embodiments of the present disclosure. Specific examples are used herein to explain the principles and implementations of the present disclosure. The descriptions of the above embodiments are only used to help understanding the technical solutions of the disclosure and the core ideas thereof. Those of ordinary skill in the art should understand that: it is still possible to modify the technical solutions described in the foregoing embodiments, or equivalently replace some technical features. These modifications or replacements do not make the nature of the corresponding technical solutions deviate from the scope of the technical solutions of the embodiments of the present disclosure.

What is claimed is:

1. A pixel driving circuit, comprising a first transistor, a second transistor, a third transistor, a fourth transistor, a first capacitor, a second capacitor, and an organic light emitting diode; the second transistor is a low-temperature polysilicon transistor; wherein
a gate of the first transistor is connected to a first node, a source of the first transistor is connected to a second node, and a drain of the first transistor is connected to a third node;
a gate of the second transistor is connected to a first scan signal, a source of the second transistor is connected to a data signal, and a drain of the second transistor is connected to the second node;
a gate of the third transistor is connected to an enabling signal, a source of the third transistor is connected to a first power signal, and a drain of the third transistor is connected to the second node;
a gate of the fourth transistor is connected to the enabling signal, a source of the fourth transistor is connected to the third node, and a drain of the fourth transistor is connected to an anode of the organic light emitting diode;
one end of the first capacitor is connected to the first power signal, and the other end of the first capacitor is connected to the first node;
one end of the second capacitor is connected to the gate of the second transistor, and the other end of the second capacitor is connected to the first node;
the anode of the organic light emitting diode is connected to the third node, and a cathode of the organic light emitting diode is connected to a second power signal.

2. The pixel driving circuit according to claim 1, wherein the first transistor, the third transistor, and the fourth transistor are low-temperature polysilicon transistors.

3. The pixel driving circuit according to claim 1, further comprising a fifth transistor; wherein a gate of the fifth transistor is connected to the first scan signal, and a first electrode of the fifth transistor is connected to the first node, and a second electrode of the fifth transistor is connected to the third node; the fifth transistor is an oxide semiconductor transistor or a low-temperature polysilicon transistor; the first electrode is a source, and the second electrode is a drain if the fifth transistor is a p-type transistor; the first electrode is a drain, and the second electrode is a source if the fifth transistor is an n-type transistor.

4. The pixel driving circuit according to claim 3, further comprising a sixth transistor; wherein a gate of the sixth transistor is connected to the second scan signal, and a first electrode of the sixth transistor is connected to the first electrode of the fifth transistor; the sixth transistor is an oxide semiconductor transistor or a low-temperature polysilicon transistor.

5. The pixel driving circuit according to claim 1, further comprising an eighth transistor and a fifth transistor; wherein
a gate of the eighth transistor is connected to the first scan signal, and a source of the eighth transistor is connected to the first node; the eighth transistor is an oxide semiconductor transistor;
a gate of the fifth transistor is connected to the first scan signal, a first electrode of the fifth transistor is connected to the first node, and a second electrode of the fifth transistor is connected to the third node; the fifth transistor is an oxide semiconductor transistor or a low-temperature polysilicon transistor; the first electrode of the fifth transistor is a source, and the second electrode of the fifth transistor is a drain if the fifth transistor is a p-type transistor; the first electrode of the fifth transistor is a drain, and the second electrode of the fifth transistor is a source if the fifth transistor is an n-type transistor.

6. The pixel driving circuit according to claim 4, further comprising a sixth transistor; wherein a gate of the sixth transistor is connected to the second scan signal, and a first electrode of the sixth transistor is connected to the first electrode of the fifth transistor; the sixth transistor is an oxide semiconductor transistor or a low-temperature polysilicon transistor.

7. The pixel driving circuit according to claim 6, wherein a second electrode of the sixth transistor is connected to a reference voltage or connected to the anode of the organic light emitting diode; the first electrode of the sixth transistor is a source, and the second electrode of the sixth transistor is a drain if the sixth transistor is a p-type transistor; the first electrode of the sixth transistor is a drain, and the second electrode of the sixth transistor is a source if the sixth transistor is an n-type transistor.

8. The pixel driving circuit according to claim 6, further comprising a seventh transistor; wherein a gate of the seventh transistor is connected to the first scan signal, a source of the seventh transistor is connected to a reference voltage, and a drain of the seventh transistor is connected to the anode of the organic light emitting diode; the seventh transistor is an oxide semiconductor transistor or a low temperature polysilicon transistor.

9. The pixel driving circuit according to claim 6, further comprising a seventh transistor; wherein a gate of the seventh transistor is connected to the enabling signal, a source of the seventh transistor is connected to a reference voltage, and a drain of the seventh transistor is connected to the anode of the organic light emitting diode; the seventh transistor is an oxide semiconductor transistor or a low temperature polysilicon transistor.

10. The pixel driving circuit according to claim 6, further comprising a seventh transistor; wherein a gate of the seventh transistor is connected to the second scan signal, a source of the seventh transistor is connected to the third node, and a drain of the seventh transistor is connected to the anode of the organic light emitting diode; the seventh transistor is an oxide semiconductor transistor or a low temperature polysilicon transistor.

11. A display panel, comprising a pixel driving circuit; wherein the pixel driving circuit includes a first transistor, a second transistor, a third transistor, a fourth transistor, a first capacitor, a second capacitor, and an organic light emitting diode; the second transistor is a low-temperature polysilicon transistor;
a gate of the first transistor is connected to a first node, a source of the first transistor is connected to a second node, and a drain of the first transistor is connected to a third node;
a gate of the second transistor is connected to a first scan signal, a source of the second transistor is connected to a data signal, and a drain of the second transistor is connected to the second node;
a gate of the third transistor is connected to an enabling signal, a source of the third transistor is connected to a first power signal, and a drain of the third transistor is connected to the second node;
a gate of the fourth transistor is connected to the enabling signal, a source of the fourth transistor is connected to the third node, and a drain of the fourth transistor is connected to an anode of the organic light emitting diode;
one end of the first capacitor is connected to the first power signal, and the other end of the first capacitor is connected to the first node;
one end of the second capacitor is connected to the gate of the second transistor, and the other end of the second capacitor is connected to the first node;
the anode of the organic light emitting diode is connected to the third node, and a cathode of the organic light emitting diode is connected to a second power signal.

12. The display panel according to claim 11, wherein the first transistor, the third transistor, and the fourth transistor are low-temperature polysilicon transistors.

13. The display panel according to claim 11, further comprising a fifth transistor; wherein a gate of the fifth transistor is connected to the first scan signal, and a first electrode of the fifth transistor is connected to the first node, and a second electrode of the fifth transistor is connected to the third node; the fifth transistor is an oxide semiconductor transistor or a low-temperature polysilicon transistor; the first electrode is a source, and the second electrode is a drain if the fifth transistor is a p-type transistor; the first electrode is a drain, and the second electrode is a source if the fifth transistor is an n-type transistor.

14. The display panel according to claim 13, further comprising a sixth transistor; wherein a gate of the sixth transistor is connected to the second scan signal, and a first electrode of the sixth transistor is connected to the first electrode of the fifth transistor; the sixth transistor is an oxide semiconductor transistor or a low-temperature polysilicon transistor.

15. The display panel according to claim 11, further comprising an eighth transistor and a fifth transistor; wherein
a gate of the eighth transistor is connected to the first scan signal, and a source of the eighth transistor is connected to the first node; the eighth transistor is an oxide semiconductor transistor;
a gate of the fifth transistor is connected to the first scan signal, a first electrode of the fifth transistor is connected to the first node, and a second electrode of the fifth transistor is connected to the third node; the fifth transistor is an oxide semiconductor transistor or low-temperature polysilicon transistor; the first electrode of the fifth transistor is a source, and the second electrode of the fifth transistor is a drain if the fifth transistor is a p-type transistor; the first electrode of the fifth transistor is a drain, and the second electrode of the fifth transistor is a source if the fifth transistor is an n-type transistor.

16. The display panel according to claim 15, further comprising a sixth transistor; wherein a gate of the sixth transistor is connected to the second scan signal, and a first electrode of the sixth transistor is connected to the first electrode of the fifth transistor; the sixth transistor is an oxide semiconductor transistor or a low-temperature polysilicon transistor.

17. The display panel according to claim 16, wherein a second electrode of the sixth transistor is connected to a reference voltage or connected to the anode of the organic light emitting diode; the first electrode of the sixth transistor is a source, and the second electrode of the sixth transistor is a drain if the sixth transistor is a p-type transistor; the first electrode of the sixth transistor is a drain, and the second electrode of the sixth transistor is a source if the sixth transistor is an n-type transistor.

18. The display panel according to claim 16, further comprising a seventh transistor; wherein a gate of the seventh transistor is connected to the first scan signal, a source of the seventh transistor is connected to a reference voltage, and a drain of the seventh transistor is connected to the anode of the organic light emitting diode; the seventh transistor is an oxide semiconductor transistor or a low temperature polysilicon transistor.

19. The display panel according to claim 16, further comprising a seventh transistor; wherein a gate of the seventh transistor is connected to the enabling signal, a source of the seventh transistor is connected to a reference voltage, and a drain of the seventh transistor is connected to the anode of the organic light emitting diode; the seventh transistor is an oxide semiconductor transistor or a low temperature polysilicon transistor.

20. The display panel according to claim 16, further comprising a seventh transistor; wherein a gate of the seventh transistor is connected to the second scan signal, a source of the seventh transistor is connected to the third node, and a drain of the seventh transistor is connected to the anode of the organic light emitting diode; the seventh transistor is an oxide semiconductor transistor or a low temperature polysilicon transistor.
